(19) United States
(12) Patent Application Publication
(10) Pub. No.: US 2021/0131850 A1
(43) Pub. Date: May 6, 2021

(54) SYSTEM AND METHOD OF FLUID DISPENSING

(71) Applicant: Zvi Ben-Shalom, Bat Hadar (IL)

(72) Inventor: Zvi Ben-Shalom, Bat Hadar (IL)

(21) Appl. No.: 16/492,138

(22) PCT Filed: Mar. 19, 2018
(86) PCT No.: PCT/IL2018/050312

§ 371 Date: Sep. 8, 2019

Related U.S. Application Data
(60) Provisional application No. 62/473,508, filed on Mar. 20, 2017.

(51) Int. Cl. G01F 11/28

(52) U.S. Cl. CPC G01F 11/28; G01F 11/284

(57) ABSTRACT

A system for dispensing fluid includes a reservoir chamber for receiving a liquid dose, said reservoir chamber in fluid flow connection with a liquid supply line via a first valve; a measuring chamber arranged in fluid flow connection with said reservoir chamber, said measuring chamber having a sensor for outputting a signal indicative of a volume of liquid in said measuring chamber; and a processor to control the operation of the first valve, based on the signal from the sensor. The system may also be used to determine liquid pressure in a liquid supply line and a volume flow rate of the liquid supply line.

### FIELD OF THE INVENTION

The present invention relates to the field of fluid dispensing, specifically in applications requiring accurate dosing, such as agricultural, medical and other technical fields.

### BACKGROUND

Dispensing chemical or biological agents into fluid reservoirs or channels is done in many industrial fields, for example, during operation of gas or oil wells or pipelines. In agriculture, chemical agents are routinely added to livestock feed and to irrigation lines, for example, during fertigation, which is the injection of fertilizers, soil amendments, and other water-soluble products into an irrigation system. Chemical agents are routinely mixed in pharmaceutical and medical procedures, for example, while preparing and/or administering medicine to patients.

The efficiency and quality of these dispensing processes are dependent mainly on being able to easily and precisely control the amounts or concentrations of agents being added.

In computerized dispensing systems used in the industry dose selection and administration of an appropriate dose are electrically controlled. The existing systems typically enable dispensing of pre-set amounts of a single agent. If a mixture of several agents is required, it must be prepared in advance or each agent must be dispensed separately. The dispensing systems being used today do not enable easily dispensing a combination of agents nor do they provide information regarding conditions in the reservoir once an agent has been dispensed into the reservoir.

Thus, if, for example, pipes of a system are partially blocked allowing only part of the dispensed agent to reach the reservoir, an incorrect or undesired concentration of agent will be used in further processes (e.g., process of fertigation). Also, undesired reactions may occur between agents and/or fluids in the reservoir and remain undetected. These and other currently unsolved problems may have an adverse effect on the quality and efficiency of currently known dispensing processes.

### SUMMARY

Systems and methods according to embodiments of the invention provide easy and efficient dispensing of agents. A fluid agent or combination of agents may be accurately dispensed into a reservoir or fluid conduit and the reservoir or conduit may be further monitored to ensure efficiency and quality of the dispensing process.

In addition, embodiments of the invention provide a method for detecting pressure in irrigation lines and using the detected pressure to dispense fluids into the irrigation lines in pulses or continuously.

According to one embodiment of the invention a dispensing system includes a measuring chamber in fluid flow connection with a reservoir chamber. Agents can be pumped into the reservoir chamber, causing the amount or volume of the fluid in the measuring chamber to rise accordingly. Inflow and/or outflow of fluids to or from the reservoir is electronically controlled by a processor.

In one embodiment the volume of fluid in the measuring chamber is detected by a sensor which is associated with the measuring container. Once a desired volume of fluid is obtained, output sent from the sensor to the processor causes the flow of agent to or from the reservoir to stop, thereby dispensing an accurate amount of agent into or from the reservoir chamber.

A system for dispensing a liquid dose into a liquid supply line, according to one embodiment of the invention, includes a reservoir chamber for receiving a liquid dose. The reservoir chamber is in fluid flow connection with a liquid supply line via a first valve. The system also includes a measuring chamber arranged in fluid flow connection with the reservoir chamber, said measuring chamber having a sensor for outputting a signal indicative of a volume of liquid in said measuring chamber. The system further includes a processor to control the operation of the first valve, based on the signal from the sensor.

In one embodiment the sensor is configured to detect a level of liquid in the measuring chamber.

In one embodiment the sensor is configured to detect a change of volume of the liquid in the measuring chamber.

In one embodiment the sensor is configured to detect a physical property in the measuring chamber.

In some embodiments the sensor includes a transmitter/receiver pair arranged on a wall of the measuring chamber. The sensor may include an electro-optical sensor to detect a level of liquid in the measuring chamber. In one embodiment the electro-optical sensor is configured to provide a spectroscopic reading of the liquid in the measuring container.

In some embodiments the system includes an electro-optic fiber connecting the sensor to the wall of the measuring chamber.

In some embodiments the sensor includes an acoustic sensor to detect a level of liquid in the measuring chamber.

In some embodiments the sensor includes a Hall effect sensor to detect a level of liquid in the measuring container.

In some embodiments the sensor includes a pressure sensor.

In one embodiment the system includes a floatable disc located within the measuring chamber and configured to float upon a body of liquid in the measuring container.

In another embodiment the system includes an expandable balloon located within the measuring chamber and configured to expand or contract according to a change in a level of liquid in the measuring chamber.

In further embodiments the system includes a liquid dose container in fluid flow connection through a second valve to said reservoir chamber. The processor controls the second valve based on the signal from the sensor. In one embodiment the processor is operative to open the second valve to allow liquid to flow from the liquid dose container into the reservoir chamber and when the volume of liquid in the measuring chamber decreases by an amount equal to a desired dose, the processor is operative to shut the second valve to stop liquid flow from the liquid dose container to the reservoir chamber.

In some embodiments the processor is operative to open the first valve to allow liquid to flow from the reservoir chamber into the liquid supply line and when the volume of liquid in the measuring chamber decreases by an amount equal to the desired dose, the processor is operative to shut the first valve to stop liquid flow from the reservoir chamber to the liquid supply line.

In some embodiments the system includes a plurality of liquid dose containers, each liquid dose container connected by a valve to said reservoir chamber for mixing a plurality of liquid doses.

The system may also include a maintenance chamber in fluid flow connection with said reservoir chamber via a third valve, wherein the processor is to control the third valve.

A system for determining liquid pressure in a liquid supply line, according to embodiments of the invention, includes a reservoir chamber in fluid flow connection with a liquid supply line via a valve, a measuring chamber arranged in fluid flow connection with said reservoir chamber, said measuring chamber having a sensor for generating a signal indicative of pressure in said measuring chamber, and a processor to selectably open the valve, and to receive a signal from the sensor corresponding to a change of pressure in said measuring chamber, thereby to determine the liquid pressure in the liquid supply line.

The system may further include a processor to determine a volume flow rate of the liquid supply line based on the signal from the sensor.

### BRIEF DESCRIPTION OF THE FIGURES

The invention will now be described in relation to certain examples and embodiments with reference to the following illustrative figures so that it may be more fully understood. In the drawings:

FIGS. 1A and 1B are schematic illustrations of systems operable according to embodiments of the invention;

FIGS. 2A, 2B and 2C are schematic illustrations of sensors operable according to embodiments of the invention;

FIGS. 3A, 3B and 3C are schematic illustrations of different sensor configurations, according to embodiments of the invention;

FIG. 4 schematically illustrates a processor unit operable according to embodiments of the invention; and

FIG. 5 is a schematic illustration of a method for monitoring properties and/or an environment of fluid in a dispensing system, according to embodiments of the invention.

### DETAILED DESCRIPTION OF THE INVENTION

Embodiments of the invention provide systems and methods for dispensing accurate doses of fluids (which may include liquids or gases). Typically, predetermined doses of fluids, e.g., fluids that contain an agent (such as a chemical for fertilization or soil enhancement or a medicinal or nutritional or other agent), are dispensed into a reservoir for further distribution to a fluid supply line, e.g., to irrigation lines.

In the following description, various aspects of the present invention will be described. For purposes of explanation, specific configurations and details are set forth in order to provide a thorough understanding of the present invention. However, it will also be apparent to one skilled in the art that the present invention may be practiced without all the specific details presented herein. Furthermore, well known features may be omitted or simplified in order not to obscure the present invention.

For example, the embodiments exemplified herein describe a system for dispensing liquids to a liquid supply line, however, it should be appreciated that embodiments of the invention may be practiced using fluids other than or in addition to liquids. Also, the embodiments exemplified herein relate mainly to dispensing systems and methods for agricultural applications, such as fertigation, however, embodiments of the invention may also be used in other technical fields. For example, systems and methods according to embodiments of the invention may be used in the food and beverage industry to dispense edibles and/or in medical uses to dispense medicines, etc.

In one embodiment a system for dispensing a fluid (e.g., liquid) dose into a fluid supply line includes a reservoir chamber for receiving a fluid dose and a measuring chamber that is in fluid flow connection with the reservoir chamber. The measuring chamber includes a sensor for outputting a signal to a processor, the signal indicative of a volume of fluid in the measuring chamber.

The reservoir chamber and measuring chamber are interconnected so as to facilitate a free flow of fluid therebetween. Thus, any amount of fluid added into the reservoir chamber will cause the volume in the measuring chamber to increase by an amount proportional to the amount added to the reservoir chamber. The sensor detects the exact increase of the volume of fluid in the measuring chamber thereby to obtain an indication of the volume of fluid added to the reservoir chamber. In one embodiment the processor, which receives signals from the sensor, controls the opening and closing of a valve connecting the reservoir chamber and a fluid supply line, thereby enabling fluid to pass between the reservoir chamber and the fluid supply line based on the signal from the sensor (namely, based on the volume of fluid in the measuring chamber), as further detailed below.

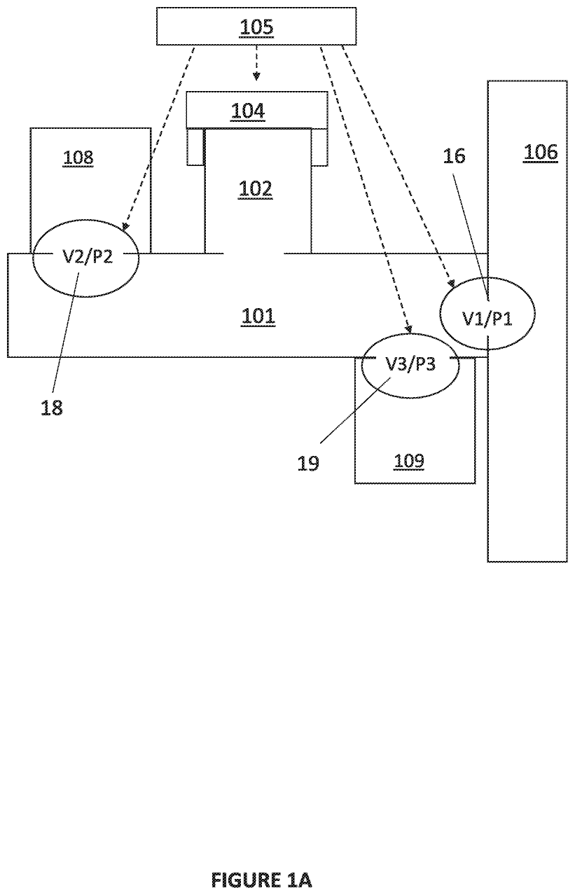

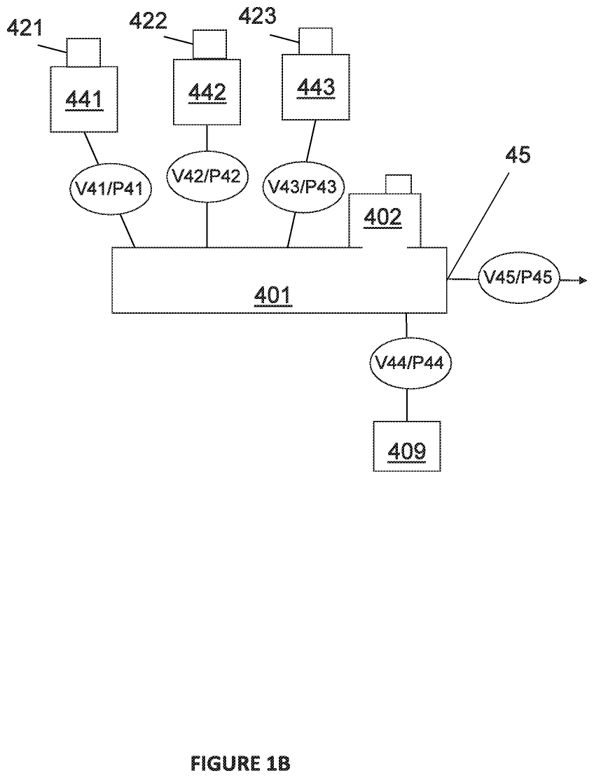

Examples of systems operable according to embodiments of the invention are schematically illustrated in FIGS. 1A and 1B.

As schematically illustrated in FIG. 1A, a system for automated liquid dispensing includes, in one embodiment, a measuring chamber 102 which is in fluid flow connection with a reservoir chamber 101, which may be a manifold or other suitably configured vessel functioning as described herein. The system further includes one or more sensors 104 to sense the volume of liquid in the measuring chamber 102. Sensor 104 may be in wired or wireless communication with a processor 105.

The reservoir chamber 101 includes openings (e.g., openings 16, 18 and 19) to enable inflow and outflow of liquids to and from the reservoir chamber 101. The inflow and outflow from the reservoir chamber 101 is typically controlled by electronic valves and if necessary, by pumps (e.g., V1/P1, V2/P2, V3/P3). Pumps may be used in cases where flow by gravitation is not sufficient or in cases where high flow rate is desired.

The system may further include one or more liquid dose containers 108. Container 108 holds a fluid (typically a liquid) to be dispensed through reservoir chamber 101 to liquid supply line 106. For example, a liquid dose container may hold a liquid fertilizer to be dispensed to an irrigation system through an irrigation line, exemplified herein as liquid supply line 106. In another example a liquid dose container may hold a medication or other chemical or biological agent to be dispensed to a patient through a tube. Other doses and dispensers can be used according to embodiments of the invention.

The system may also include one or more maintenance chambers 109, in fluid flow connection with reservoir chamber 101. Flow of liquid from reservoir chamber 101 to maintenance chamber 109 via valve V3 may be used to sample fluids from the reservoir chamber 101. Liquid may be pumped by pump P3 from maintenance chamber 109 into reservoir chamber 101 to rinse reservoir chamber 101. Maintenance chamber 109 may be used to let out air bubbles trapped in the system and for other maintenance purposes.

Inflow of liquid from one or more liquid dose container(s) 108 and/or other sources, such as maintenance chamber 109, both of which are in fluid flow connection with reservoir chamber 101, is controlled by respective valves V2 and V3 and by optional pumps P2 and P3, respectively. Outflow of liquid from the reservoir chamber 101, typically to liquid supply line 106, is controlled by valve V1 and optionally by pump P1.

Measuring chamber 102 is of known dimensions such that the volume of a fluid therein can be determined by measurement of the level or height of a body of fluid therein. Similarly, the detection of a change in fluid level is indicative of a known change in fluid volume in measuring chamber 102.

Thus, in one embodiment, the sensor 104 detects a level of liquid in the measuring chamber 102. The sensor 104 may detect a change of volume of the liquid in the measuring chamber, e.g., by detecting a change of level of the liquid in the measuring chamber 102.

Also, physical properties (such as pressure and temperature) within a measuring chamber 102 of known dimensions can be used to determine the volume of fluid in the measuring chamber 102, using known fluid mechanics laws. Thus, in one embodiment the sensor 104 detects a physical property in the measuring chamber 102.

Because measuring chamber 102 and reservoir chamber 101 are in mutual fluid communication, a given volume of liquid entering or exiting reservoir chamber 101 causes a corresponding change in the volume of liquid in the measuring chamber 102 and, a corresponding pressure change inside the measuring chamber 102.

The level of fluid or pressure or another indication (as further exemplified below) of the volume of liquid in measuring chamber 102 is detected by sensor 104 associated with the measuring chamber 102. A signal output from sensor 104, indicative of liquid volume in measuring chamber 102, is provided to processor 105, and is used thereby to control inflow and/or outflow from reservoir chamber 101. This is done by issuing electronic signals to open or close the valves, and/or activate or deactivate the pumps and/or other mechanisms so as to regulate inflow and outflow between reservoir chamber 101 and supply line 106.

Thus, once a specific volume or dose of liquid enters reservoir chamber 101, e.g., from liquid dose container 108, it is detected by sensor 104 due to the change of volume of liquid in measurement chamber 102.

Processor 105 controls the valve V2 (and optionally the pump P2) which regulates flow between the liquid dose container 108 and reservoir chamber 101, based on the signal from the sensor 104. Thus, in one embodiment, the processor 105 is operative to open the valve V2 to allow liquid to flow from the liquid dose container 108 into the reservoir chamber 101 and when the volume of liquid in the measuring chamber 102 increases by an amount proportional to a desired dose, the processor 105 is operative to shut the valve V2 to stop liquid flow from the liquid dose container 108 to the reservoir chamber 101. Once a desired dose has thus been dispensed from the liquid dose container 108 into the reservoir chamber 101 the processor 105 may open the valve V1 to allow liquid to flow from the reservoir chamber 101 into the liquid supply line 106. When the volume of liquid in the measuring chamber 102 decreases by an amount proportional to the desired dose, the processor 105 shuts the valve V1 to stop liquid flow from the reservoir chamber 101 to the liquid supply line 106, thereby dispensing an exact dose of liquid from the liquid dose container 108 via the reservoir chamber 101 to the liquid supply line 106.

Similarly valve V3 that regulates flow to or from the maintenance chamber 109 from or to reservoir chamber 101, may be controlled by a processor, such as processor 105.

The sensor 104 may include an electro-optical sensor to detect a level of liquid in the measuring chamber 102. In another embodiment the sensor 104 may include an acoustic sensor to detect a level of liquid in the measuring chamber 102. In yet another embodiment the sensor 104 may include a Hall effect sensor to detect a level of liquid in the measuring container 102. In some embodiments the sensor 104 includes a pressure sensor.

In some embodiments the system is used for determining pressure in a liquid supply line, as described hereinbelow. In this embodiment the sensor 104 generates a signal indicative of pressure in the measuring chamber 102.

Once the pressure in the measuring chamber 102 is known, any change of pressure in the measuring chamber 102, due to opening of the valve V1, is indicative of the pressure in the liquid supply line 106. For example, if the pressure in the liquid supply line 106 decreases and becomes lower than the pressure in the reservoir chamber 101, opening the valve V1 will cause the pressure in the reservoir chamber 101 to decrease correspondingly. causing a corresponding change of pressure (and change of volume of liquid) in the measuring chamber 102.

The processor 105 can be programmed to selectably open the valve V1 between the reservoir chamber and the liquid supply line 106 and can receive a signal from the sensor 104 corresponding to a change of pressure in the measuring chamber 102, to determine the liquid pressure in the liquid supply line 106.

The sensor 104 may generate a signal indicative of pressure in the measuring chamber by sensing a physical property in the measuring chamber (e.g., pressure) and/or by detecting a volume of liquid in the measuring chamber.

A system according to embodiments of the invention may be used for continuous dispensing (as opposed to or in addition to the pulse type dispensing described above).

In one exemplary embodiment valve V1 is opened so that the pressure in the reservoir chamber 101 (which can be known from the volume of liquid in the measuring chamber 102) and the liquid supply line 106 becomes equal. Using a pump, e.g., pump P2, liquids can be pumped into the reservoir chamber 101, thereby raising the pressure in the reservoir chamber 101 above the pressure in the liquid supply line 106. As long as the pressure in the reservoir chamber 101 is higher than the pressure in the liquid supply line 106, liquid will continue to pass from the reservoir chamber 101 to the liquid supply line 106, in accordance with known fluid mechanics laws, enabling the continuous dispensing of liquid e.g., form liquid dose container 108 into the liquid supply lie 106 via the reservoir chamber.

Thus, having a pressure sensor in the system improves control and monitoring of the dispensing process.

Additionally, in an embodiment of the invention, the processor 105 may be programmed to determine a volume flow rate of the liquid supply line based on the signal from the sensor 105 and application of known equations for evaluating the flow of a liquid.

As can be appreciated from the description above, systems according to embodiments of the invention provide a method for accurately measuring liquid doses prior to dispensing. In some embodiments accurately measured amounts of liquids may be mixed prior to being dispensed, enabling easy dispensing of a dose of a mixture, e.g., a mixture of fertilizers, instead of having to dispense each component of the mixture separately.

In some embodiments a reservoir chamber may have multiple inlets and/or outlets.

FIG. 1B schematically illustrates a system capable of administering or dispensing a sequence of different agents and/or a combination of agents. In this embodiment a mixing tank or manifold 401, which may be in fluid flow connection with a measuring chamber 402 having a sensor as described above, receives inflow from multiple reservoir chambers 441, 442 and 443. The inflow from each of the reservoir chambers is regulated by valves, V41, V42 and V43, (and optional pumps P41, P42 and P43) correspondingly. Each of the multiple reservoir chambers 441, 442 and 443 may include its own measuring chamber 421, 422 and 423 and sensor to detect the volume of liquid in each measuring chamber. Manifold 401 may also be in fluid flow connection with a flushing tank 409, through valve V44 (and optional pump P44). Manifold 401 also includes an outlet 45 to a liquid supply line, e.g., an irrigation line, the outlet being regulated by valve V45 and by optional pump P45.

During operation, different agents (e.g., different fertilizers) may be accurately dispensed from each of reservoir chambers 441, 442 and 443, possibly using measuring chambers 421, 422 and 423, according to embodiments of the invention.

According to a schedule pre-programmed into a control unit (e.g., a control unit which includes processor 105), valves V41, V42 and V43 (and possibly pumps P41, P42 and P43) may be opened or closed to regulate flow into manifold 401 of predetermined doses of the different fertilizers. Each valve may be controlled based on detection of a decrease in the volume of liquid in its corresponding measuring containers and/or based on an increase in the volume of liquid in measuring chamber 402, for example, as described above. Once all the doses are mixed in manifold 401, a desired dose of the mixture can be dispensed to a liquid supply line. As described above, a processor receives signals from the sensor monitoring the measuring chamber 402, thereby controlling valve V45 to be open until a desire decrease of volume is detected in measuring chamber 402, at which point the valve V45 is closed.

Thus, a sequence of fertilizers may be accurately and timely dispensed into manifold 401 and then let into the irrigation lines. Flushing fluid from flushing tank 409 may be pumped into manifold 401 by pump P44 in between doses to wash out the manifold 401 from the previous mixture of agents prior to receiving a new mixture, to enable different doses to be dispensed without fear of contamination.

Liquids may pass between reservoir chambers 441, 442 and 443 and manifold 401 and/or between manifold 401 and flushing tank 409 and/or irrigation pipes due to a pressure gradient or gravity or by the operation of pumps, e.g., pumps P44 and P45.

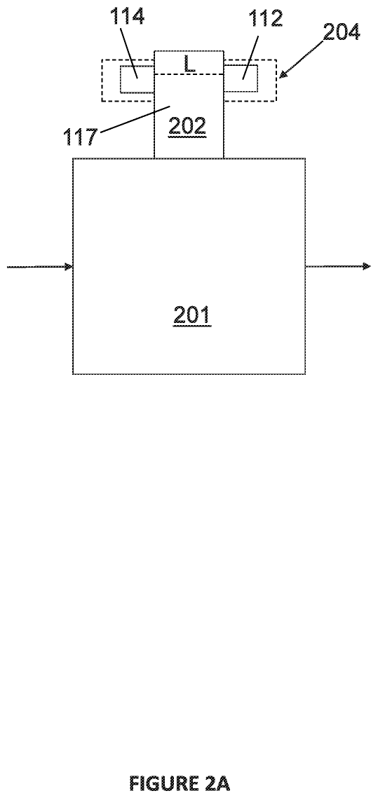

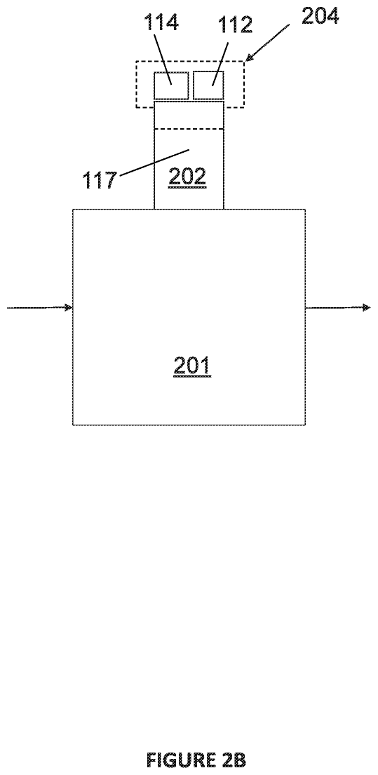

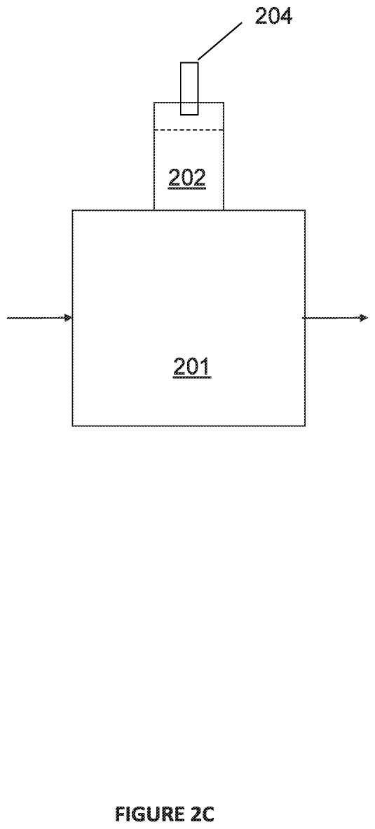

A few examples of sensors operable according to embodiments of the invention are schematically illustrated in FIGS. 2A, 2B and 2C.

A system which includes a measuring chamber 202 which is in fluid low connection with a reservoir chamber 201, also included a sensor 204 to sense the volume of liquid in the measuring chamber 202. It should be appreciated that a sensor according to embodiments of the invention may include one or several sensors which may be associated with a measuring chamber at any (one or more) suitable locations. A sensor may be arranged over part or all of the measuring chamber wall, as exemplified below.

In one embodiment, the sensor 204 includes a transmitter/receiver pair arranged on a wall of the measuring chamber 202. The transmitter/receiver pair may be arranged on opposing walls of the measuring chamber, as schematically illustrated in FIG. 2A, or arranged side by side on one end of the measuring chamber, as schematically illustrated in FIG. 2B.

In the example illustrated in FIG. 2A, sensor 204 includes an optical sensor, using optical techniques to detect the level of liquid in measuring container 202. For example, sensor 204 may include a transmitter 112/receiver 114 pair to transmit and receive light through measuring chamber 202. Other outputs may be transmitted and received, e.g., acoustic signals or a magnetic field.

In the example schematically illustrated in FIG. 2A the transmitter 112/receiver 114 pair is configured such that the transmitter 112 is located opposite the receiver 114 on the circumference of the measuring chamber 202, the body of liquid 117 flowing up or down in between the transmitter 112 and receiver 114. In this example, light (or another output) transmitted from transmitter 112 is meant to be received by receiver 114 across the inner space of measuring chamber 202. Light (or for example, sound or ultrasound waves) passing an empty space in measuring chamber 202 will be received by receiver 114 differently than light passing through liquid in measuring chamber 202. Thus, based on whether the level of fluid is higher or lower than the line of sight L between the transmitter 112 and receiver 114, different signals will be output from receiver 114.

In this embodiment the transmitter 112/receiver 114 pair may be located on the circumference of measuring chamber 202, on the outside of the chamber or embedded within the walls of the chamber. The measuring chamber 202 may be made of at least partially transparent material such as glass, synthetic plastics (e.g., PVC), Teflon®, etc, to allow light from transmitter 112 pass through its walls. In some embodiments the measuring chamber 202 is covered by an opaque covering (e.g., a coating or a sleeve or casing) to prevent external light from interfering with the measurements. Thus, for example, the measuring chamber 202 may be made of transparent material but may be coated with opaque material except for where the transmitter 112/receiver 114 pairs are located along the measuring chamber 202 wall.

In some embodiments measuring chamber 202 is made of typically non-magnetic material so as not to interfere with the sensor if it is a magnetic field sensor (e.g., Hall effect sensor).

For simplicity, FIG. 2A demonstrates only one transmitter 112/receiver 114 pair, however a plurality of transmitter 112/receiver 114 pairs may be positioned along the entire or part of the length of the measuring chamber 202 wall.

In the embodiment schematically illustrated in FIG. 2B the transmitter 112/receiver 114 pair is configured such that the transmitter 112 and receiver 114 are located side by side on an end of the measuring chamber 202, the body of fluid 117 moving towards or away from the transmitter 112 and receiver 114. In this example, light or other signal output transmitted from transmitter 112 is received by receiver 114 after being reflected from the opposite end of the measuring chamber 202, or, typically, after being reflected from the body of fluid 117 rising or dropping in the measuring chamber 202. The interference created by light being reflected from the fluid in the measuring chamber 202 and received at receiver 114 may be used to determine the distance of the liquid from the sensor 204 and/or to determine the density of the liquid. Similarly, acoustic or light waves may be used to determine the distance of the liquid from sensor 204 using the Doppler effect. In some embodiments spread spectrum techniques may be used to determine the distance of the liquid from sensor 204.

Thus, the level of fluid in measuring chamber 202 can be detected based on waves or energy transmitted from transmitter 112 and reflected to receiver 114 after having hit the body of fluid 117 in measuring chamber 202.

In one embodiment sensor 204 includes a light sensor. For example, transmitter 112 includes a light source (e.g., UV, IR, visible light or other suitable light wavelengths) and receiver 114 includes an appropriate light sensor. In another embodiment sensor 204 may be an acoustic sensor and may include, for example, an ultrasound or Doppler or other appropriate transceiver.

In some embodiments sensor 204 includes a magnetic field or Hall effect sensor, as further described below.

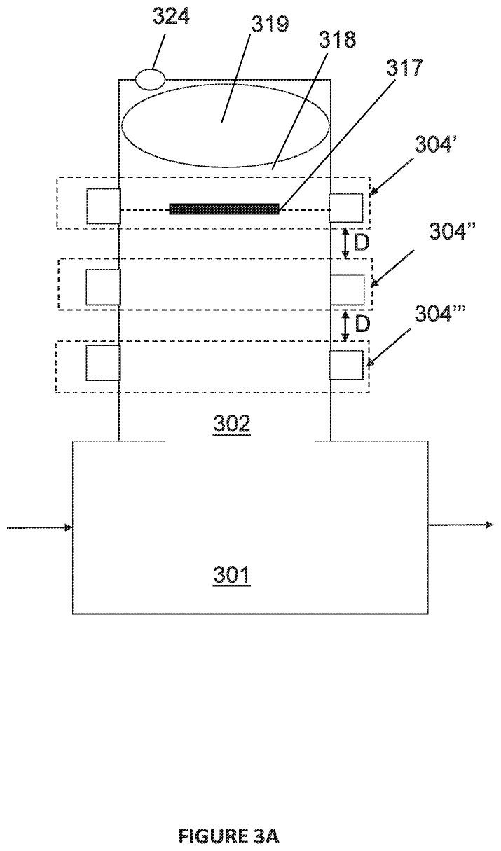

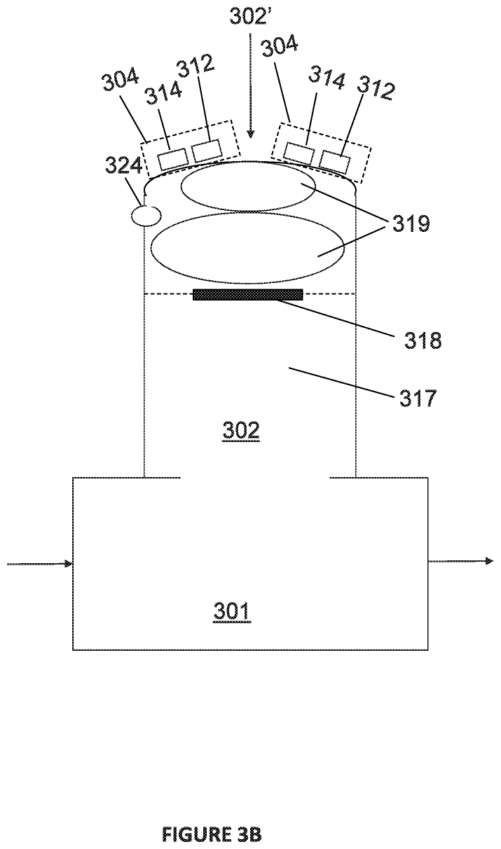

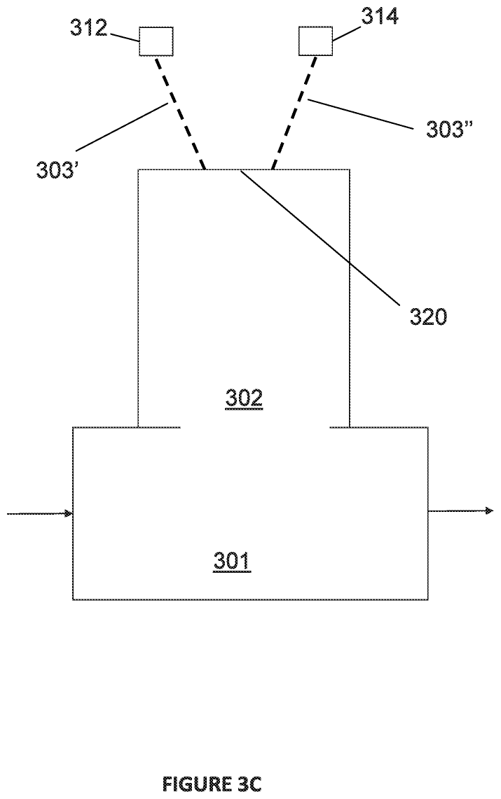

In one embodiment, which is further described in detail with reference to FIG. 3C below, the light source or other energy source) of transmitter 112 may be located at a distance from the transmitter 112 and light or other transmitted energy may be conveyed from the light source to the wall of the measuring chamber 202 via optical fibers. Similarly, light or other energy transmitted to at the wall of the measuring chamber 202 may be conveyed to receiver 114, which may be located at a distance from the measuring chamber 202, through optical fibers.

In an embodiment, which is schematically illustrated in FIG. 2C, sensor 204 includes a pressure sensor that can detect the pressure in measuring chamber 202. An increase or decrease of the volume of liquid in measuring chamber 202 causes a corresponding change in pressure therewithin, enabling a determination of the volume of liquid in the measuring container 202 by measuring pressure therewithin. As further described below, determining volume by use of pressure measurement in the measuring container enables effective control and monitoring of the dispensing process.

In one embodiment, the pressure in the measuring container may be used as a parameter in calculations of the speed of acoustic waves (e.g., when an acoustic sensor is used) or the absorption of light (e.g., when a light sensor is used). Thus, in some embodiments a combination of sensors is used, for example, a pressure sensor and a light or acoustic sensor.

According to some embodiments of the invention the sensor 204 or an additional sensor may be used to detect properties of the fluid in the measuring chamber. Because the measuring chamber 202 and reservoir chamber 201 are in fluid flow connection, liquid in the measuring chamber has the same properties as the liquid in the reservoir chamber. Thus, detecting properties of liquid in the measuring chamber may be indicative of the properties of the liquid in the reservoir chamber.

For example, sensor 204 may include a spectroscopic sensor to provide spectroscopic reading of the liquid in the measuring chamber 202, and may detect viscosity of a liquid or an amount of particles in a liquid based on the spectroscopic reading of the liquid. In another embodiment sensor 104 may include an image sensor or photodetector, and may detect properties such as color of a fluid.

In one embodiment a pressure sensor and light sensor are used to detect components of a mixture in the measuring chamber 202. For example, a table of the light absorption of a fluid containing known agents (e.g., sulfur, phosphates and other agents used for fertilization) at different pressures may be compared against the light absorbed of the fluid in the measuring chamber 202, at the pressure measured in the measuring chamber 202. The different solvents in the liquid in the measuring chamber 202 may thus be determined.

Various examples of configurations of sensors are schematically illustrated in FIGS. 3A, 3B and 3C.

FIGS. 3A and 3B depict a measuring chamber 302 containing a body of liquid 317. In one embodiment a floating disc 318 or other floating element may be placed within the measuring chamber 302 such that the disc 318 is carried by the body of liquid in the measuring chamber, rising or dropping together with the rise and fall of the body of liquid 317.

In the example depicted in FIG. 3A, a transmitter/receiver pair is configured such that the transmitter is located opposite the receiver, for example as illustrated in FIG. 2A. In this example a plurality of transmitter/receiver pairs 304′, 304″ and 304′″ are arranged at preset, typically ascending, distances D on the circumference of measuring chamber 302, such that the body of liquid 317 (and optionally a disc 318 which floats on the body of liquid 317) flows in between the transmitter and receiver of each pair.

In one embodiment balloon 319 containing a gas, such as air, is placed within the measuring chamber 302 such that the balloon 319 contracts or expands together with the rise or fall of the body of liquid 317, to facilitate detection of the level of liquid in measuring chamber 302.

In some embodiments the distances D are equal, thus transmitter/receiver pairs 304′, 304″ and 304′″ are arranged at equal distances from each other along the wall of measuring chamber 302. However, distances D do not have to be equal. The distances D may be created according to a curve of any function suitable for deducing the volume of liquid from the displacement of the body of liquid within the measuring chamber 302.

In the example depicted in FIG. 3B a sensor or plurality of sensors 304 are located at one end 302′ of measuring chamber 302. As schematically shown in FIG. 3B, the end of the measuring chamber may be dome shaped or any other appropriate shape.

In one embodiment each of the sensors 304 includes a transmitter 312/receiver 314 pair configured such that the transmitter 312 and receiver 314 are located side by side on an end 302′ of the measuring chamber 302. In this embodiment the body of liquid 317 (and optionally a disc 318 which floats on the body of liquid 317) flows towards or away from the transmitter/receiver pair.

In one embodiment, disc 318 is made of reflecting material to facilitate reflection of energy transmitted from transmitter 312 to the disc 318 and from the disc 318 to the receiver 314. In one embodiment the sensor 304 includes a Hall effect sensor and the floating disc 318 contains a magnet, thus the proximity of the floating disc 318 to the sensor 304 may be determined indicating rise or fall of the body of liquid 317.

In one embodiment one or more air or other gas balloons 319 are placed within the measuring chamber 302 such that the balloons 319 contracts or expands together with the rise or fall of the body of liquid 317, to facilitate detection of the level of liquid in measuring chamber 302. Typically, embodiments which include one or more balloons 319, include a sensor 304 which is a pressure sensor or a magnetic sensor, rather than an acoustic or light sensor.

Some embodiments include an auxiliary sensor, such as auxiliary sensor 324. Auxiliary sensors may include sensors to determine properties of the liquid in the measuring chamber and/or to determine environment parameters in the measuring chamber. For example, an auxiliary sensor may include an image sensor or photodetector to determine properties of the liquid and/or a temperature and/or pressure sensor to determine the temperature and/or pressure in the measuring chamber and/or of the fluid in the measuring chamber.

An auxiliary sensor 324 may be embedded or placed in the measuring chamber 302, typically to detect conditions of the environment in the measuring chamber and possibly to detect properties of the liquid in the measuring chamber. Signals from the auxiliary sensor 324 are sent either continually or periodically, either wirelessly or by wired connection, to a processor (e.g., processor 105) for further analysis to monitor properties of the liquid in the measuring chamber 302 and/or conditions in the measuring chamber 302.

An auxiliary sensor 324 may include sensors to detect properties of a fluid such as the electrical conductivity of the fluid, pH, temperature of the fluid, etc.

An auxiliary sensor 324 may include a sensor to detect temperature and/or other environmental conditions in the measuring chamber.

In some embodiments auxiliary sensor 324 includes an accelerometer or other sensor to detect movement of the measuring chamber, e.g., to detect if the measuring chamber (or other parts or the whole system) is not positioned as it should be, if the system is falling, etc.

In another optional embodiment the sensor is located remotely from the measuring chamber and an optical fiber connects the sensor to the measuring chamber. In this embodiment, which is schematically illustrated in FIG. 3C, at least some or all of the components of a sensor, e.g., transmitter 312 and receiver 314, are located remotely rather than attached to the walls 320 of measuring container 302. A signal (e.g., light) from transmitter 312 can be brought to the walls 320 of the measuring container 302 by an optic fiber 303′ and the signal meant to be received by receiver 314 can be brought to the receiver 314 from the walls 320 of the measuring container 302 by an optic fiber 303″. Other fibers configured to propagate signals other than light signals may be used with appropriate sensors.

The fibers 303′ and 303″ may be located opposite each other as described e.g., with reference to the transmitter/receiver pair in FIG. 2A, or side by side as described e.g., with reference to the transmitter/receiver pair in FIG. 2B.

Similarly, at least some or all of the components of an auxiliary sensor (e.g., auxiliary sensor 324) can be located remotely and signals from the measuring chamber may be propagated to the remote sensor from the measuring chamber inner space or wall through an appropriate fiber.

One advantage of this embodiment is that sensitive components of the system may be kept in a protected location, away from the typically moist environment of the measuring and reservoir chambers.

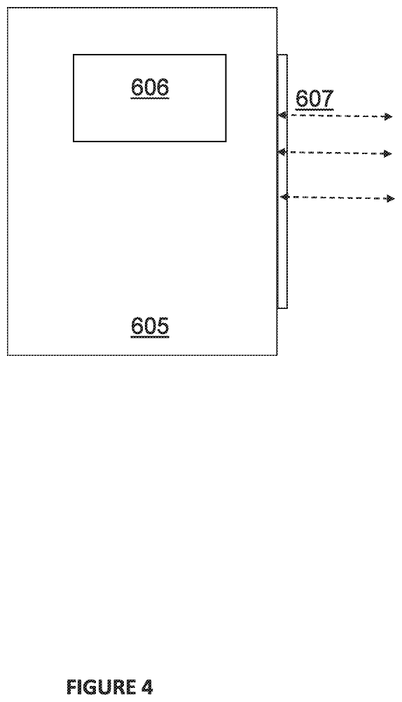

A processor which is part of a control unit, according to an embodiment of the invention, is schematically illustrated in FIG. 4.

The control unit 600 typically includes a processor 605, a user interface 606 and a bus 607 which can include a communication port (e.g., Wi-Fi, Bluetooth, cellular etc.) and ports for optical fibers and connections for electric components such as the transmitter (e.g., light source) and receiver (e.g., light sensor), auxiliary sensors, valves and pumps and other electronic components of the system.

Processor 605 may include, for example, one or more processors and may include a central processing unit (CPU), a digital signal processor (DSP), a microprocessor, a controller, a chip, a microchip, an integrated circuit (IC), or any other suitable multi-purpose or specific processor or controller. The processor 605 may include or may be connected to a memory unit or storage unit, which may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

According to some embodiments, operation schedules or instructions (e.g., schedule of fertilization and doses), as well as a log of events or other operations of the processor, may be stored in the memory unit. Processor 605 can maintain and run appropriate algorithms to analyze input from the sensor and to control valves and pumps accordingly and/or to output information to a user, such as pressure and volume flow rate in irrigation lines.

In some examples, image analysis algorithms may be used in combination with methods according to embodiments of the invention to determine a level of a fluid in a measuring chamber and/or to determine conditions in the measuring chamber. Additionally, image analysis or other appropriate algorithms may be used to detect parameters of the fluid (such as viscosity, amount of particles in the fluid, components of the fluid, etc.) from input received from the sensors and/or auxiliary sensors.

The processor 605 may also control the user interface 606 which may include a display and possibly buttons (not shown) or other controls enabling a user to program the system and/or monitor the system's operation.

According to one embodiment the processor 605 is part of an irrigation processing unit that can receive an indication of a volume of liquid in a measuring chamber that is in fluid flow connection with a reservoir chamber and can control a valve and/or pump regulating the reservoir chamber, based on the received indication. The irrigation processing unit may thus control irrigation and fertigation.

The irrigation processing unit can also detect properties of the liquid in the measuring chamber and/or conditions in the measuring chamber, based on signals from a sensor and/an auxiliary sensor associated with the measuring chamber. Processor 605 may cause the properties of the liquid in the measuring chamber and/or the conditions in the measuring chamber to be displayed on a user interface.

In some embodiments the irrigation processing unit can calculate pressure and/or volume flow rate in a line which is in fluid flow connection the reservoir chamber, based on the received indication.

Methods according to embodiments of the invention may be carried out using a system and control unit such as described above.

In the following description and throughout the specification, discussions utilizing terms such as “processing,” “computing,” “calculating,” “determining,” “detecting”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

In one embodiment a method for dispensing doses of a chemical (or other) agent from a liquid dose container, includes receiving a signal from a sensor (e.g., as described herein), the signal indicative of a volume of fluid in a measuring chamber that is in fluid flow connection with a reservoir (as described herein) and, based on the received signal, controlling the flow from the liquid dose container into the reservoir.

In one embodiment the sensor may detect the volume of liquid in the measuring chamber based on detection of the level of liquid in the measuring container. In one embodiment the sensor detects the volume of liquid in the measuring chamber from a physical property detected in the measuring chamber, such as the pressure in the measuring chamber.

In one embodiment a method for dispensing includes receiving at a processor an indication of a volume of fluid in a measuring chamber which is in fluid flow connection with a reservoir chamber, and using the processor to control inflow or outflow from the reservoir chamber based on the volume of fluid in the measuring chamber. The processor may be used to dispense fertilizing agents to an irrigation line and/or in other dispensing procedures.

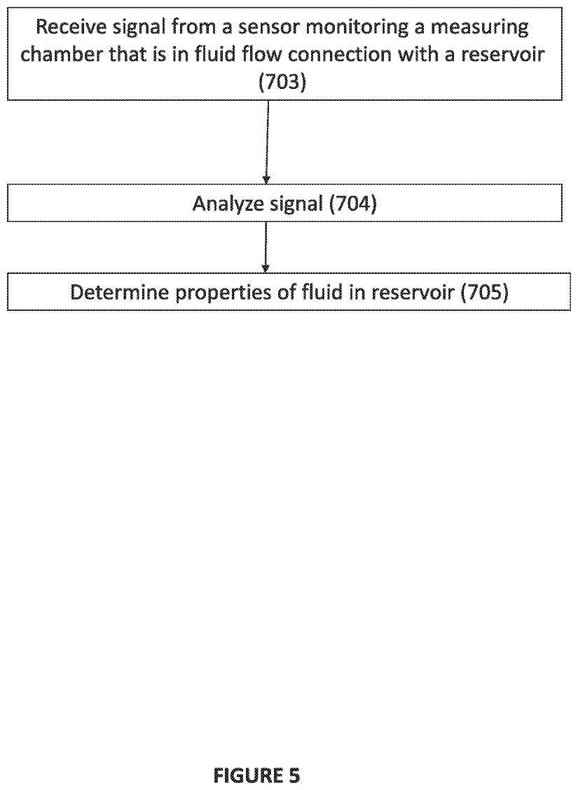

In one embodiment properties of a liquid in a dispensing system are monitored. In one embodiment a method, which is schematically illustrated in FIG. 5, includes receiving a signal from a sensor monitoring a measuring chamber that is in fluid flow connection with a reservoir (703). The sensor may be a sensor used to sense the volume of liquid in the measuring chamber and/or an auxiliary sensor. The signal is analyzed (704), typically by a processor such as processor 105 or 605, and, based on the analysis, determining properties of the liquid in the reservoir (705).

In one example, viscosity of the liquid and/or an amount of particles in the liquid and/or a color of the liquid may be determined based on a spectroscopic analysis of signals received from an optical sensor.

Among other advantages, accurate dispensing provided by embodiments of the invention enables micro-dosing, namely, dispensing small amounts of agents on a regular basis. Micro-dosing and use of the systems and methods according to embodiments of the invention can be advantageous to customers (e.g., in the food/beverage field), to patients (e.g., in the medical field) and the environment (e.g., in industrial and/or agricultural fields).

1. A system for dispensing a liquid dose into a liquid supply line, the system comprising:
a reservoir chamber for receiving a liquid dose, said reservoir chamber in fluid flow connection with a liquid supply line via a first valve;
a measuring chamber arranged in fluid flow connection with said reservoir chamber, said measuring chamber having a sensor for outputting a signal indicative of a volume of liquid in said measuring chamber; and
a processor to control the operation of the first valve, based on the signal from the sensor.

2. The system of claim 1 wherein the sensor is configured to detect a level of liquid in the measuring chamber.

3. The system of claim 1 wherein the sensor is configured to detect a change of volume of the liquid in the measuring chamber.

4. The system of claim 1 wherein the sensor is configured to detect a physical property in the measuring chamber.

5. The system of claim 1 wherein the sensor comprises a transmitter/receiver pair arranged on a wall of the measuring chamber.

6. The system of claim 5 wherein the sensor comprises an electro-optical sensor to detect a level of liquid in the measuring chamber.

7. The system of claim 6 wherein the electro-optical sensor is configured to provide a spectroscopic reading of the liquid in the measuring container.

8. The system of claim 6 comprising an electro-optic fiber connecting the sensor to the wall of the measuring chamber.

9. The system of claim 5 wherein the sensor comprises an acoustic sensor to detect a level of liquid in the measuring chamber.

10. The system of claim 1 wherein the sensor comprises a Hall effect sensor to detect a level of liquid in the measuring container.

11. The system of claim 1 wherein the sensor comprises a pressure sensor.

12. The system of claim 1 comprising a floatable disc located within the measuring chamber and configured to float upon a body of liquid in the measuring container.

13. The system of claim 1 comprising an expandable balloon located within the measuring chamber and configured to expand or contract according to a change in a level of liquid in the measuring chamber.

14. The system of claim 1 further comprising a liquid dose container in fluid flow connection through a second valve to said reservoir chamber; and wherein the processor is to control the second valve based on the signal from the sensor.

15. The system of claim 14 wherein the processor is operative to open the second valve to allow liquid to flow from the liquid dose container into the reservoir chamber; and when the volume of liquid in the measuring chamber decreases by an amount equal to a desired dose, the processor is operative to shut the second valve to stop liquid flow from the liquid dose container to the reservoir chamber.

16. The system of claim 15 wherein the processor is operative to open the first valve to allow liquid to flow from the reservoir chamber into the liquid supply line; and when the volume of liquid in the measuring chamber decreases by an amount equal to the desired dose, the processor is operative to shut the first valve to stop liquid flow from the reservoir chamber to the liquid supply line.

17. The system of claim 14 comprising a plurality of liquid dose containers, each liquid dose container connected by a valve to said reservoir chamber for mixing a plurality of liquid doses.

18. The system of claim 1 comprising a maintenance chamber in fluid flow connection with said reservoir chamber via a third valve; wherein the processor is to control the third valve.

19. A system for determining liquid pressure in a liquid supply line, the system comprising:
a reservoir chamber in fluid flow connection with a liquid supply line via a valve;
a measuring chamber arranged in fluid flow connection with said reservoir chamber, said measuring chamber having a sensor for generating a signal indicative of pressure in said measuring chamber; and
a processor to selectably open the valve, and to receive a signal from the sensor corresponding to a change of pressure in said measuring chamber, thereby to determine the liquid pressure in the liquid supply line.

20. The system of claim 19 comprising a processor to determine a volume flow rate of the liquid supply line based on the signal from the sensor.
